(19) United States
(12) Patent Application Publication
(10) Pub. No.: US 2009/0254968 A1
(43) Pub. Date: Oct. 8, 2009

(54) METHOD, SYSTEM, AND COMPUTER PROGRAM PRODUCT FOR VIRTUAL WORLD ACCESS CONTROL MANAGEMENT

(75) Inventors: Anthony Bussani, Adliswil (CH); Jan L. Camenisch, Thalwil (CH); Thomas R. Gross, Zurich (CH); Dirk Husemann, Einsiedein (CH); Ansgar Schmidt, Leinfelden-Echterdingen (DE); Dieter Sommer, Zurich (CH)

Correspondence Address: Cantor Colburn LLP-IBM Europe, 20 Church Street, 22nd Floor, Hartford, CT, 06103, US

(73) Assignee: International Business Machines Corporation, Armonk, NY (US)

(21) Appl. No.: 12/062,066

(22) Filed: Apr. 3, 2008

(51) Int. Cl. G06F 21/00

(52) U.S. Cl. 726/1

(57) ABSTRACT

A method for virtual world (VW) access control management includes intercepting a policy object from a VW network in response to a request from a VW client system to access a VW space, the policy object intercepted by a proxy server located outside of the network. The method also includes selecting an identity based upon the policy object, which provides credentials required in the policy object as a condition of granting access to the network, generating proof from the selected identity, and transmitting the proof to a verifier avatar located inside the network, the verifier avatar logically mapped to, and controlled by, a verification system located outside of the network. The method further includes receiving, at the verification system, the proof from the verifier avatar. In response to successful validation of the proof, the verification avatar places an avatar of the client system on a list of avatars having access to the space.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to access control management, and particularly to a method, system, and computer program product for virtual world access control management.

2. Description of Background

Before our invention, access control for virtual world spaces (e.g., islands, parcels, sims) was usually controlled through group membership. That is, e.g., only if a user's avatar is a member of a certain group will she gain access to a specific private (i.e., non-public, access restricted) virtual world space. Currently, group membership is done manually on a user-by-user basis or may be based on a set of certain attributes (e.g., all users registered in an external LDAP directory who have a certain attribute set) where the user and the group maintaining entity have a pre-existing relationship (e.g., users are registered in the LDAP directory). When no such previous relationship exists, it currently is not possible to automate the group membership process, and manual intervention is required, oftentimes necessitating the loss of anonymity on the part of the user.

What is needed, therefore, is a solution which allows a user to prove certain attributes about himself in an anonymous fashion to become a member of a virtual world (VW) group, and thus gain access to virtual world (VW) spaces.

### SUMMARY OF THE INVENTION

The shortcomings of the prior art are overcome and additional advantages are provided through the provision of a method for virtual world (VW) access control management. The method includes intercepting a policy object from a VW network in response to a request from a VW client system to access a VW space, the policy object intercepted by a proxy server located outside of the VW network. The method also includes selecting an identity based upon the policy object, the identity selected providing credentials requested through the policy object as a condition of granting access to the VW network, generating proof from the selected identity, and transmitting the proof to a verifier avatar located inside the VW network, the verifier avatar logically mapped to, and controlled by, a verification system that is located outside of the VW network. The method further includes receiving, at the verification system, the proof from the verifier avatar. In response to successful validation of the proof, the verification avatar places an avatar associated with the VW client system on a list of avatars having access to the VW space.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which allows a user to prove certain attributes about himself, possibly in an anonymous fashion, to become a member of a virtual world (VW) group, and thus gain access to virtual world (VW) spaces. Our VW group maintenance system verifies the proof without any pre-existing relationship with the user.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which virtual world (VW) access control management may be performed; and

FIG. 2 illustrates one example of a flow diagram describing a process for implementing VW access control management.

The detailed description explains the preferred embodiments of the invention, together with advantages and features, by way of example with reference to the drawings.

### DETAILED DESCRIPTION OF THE INVENTION

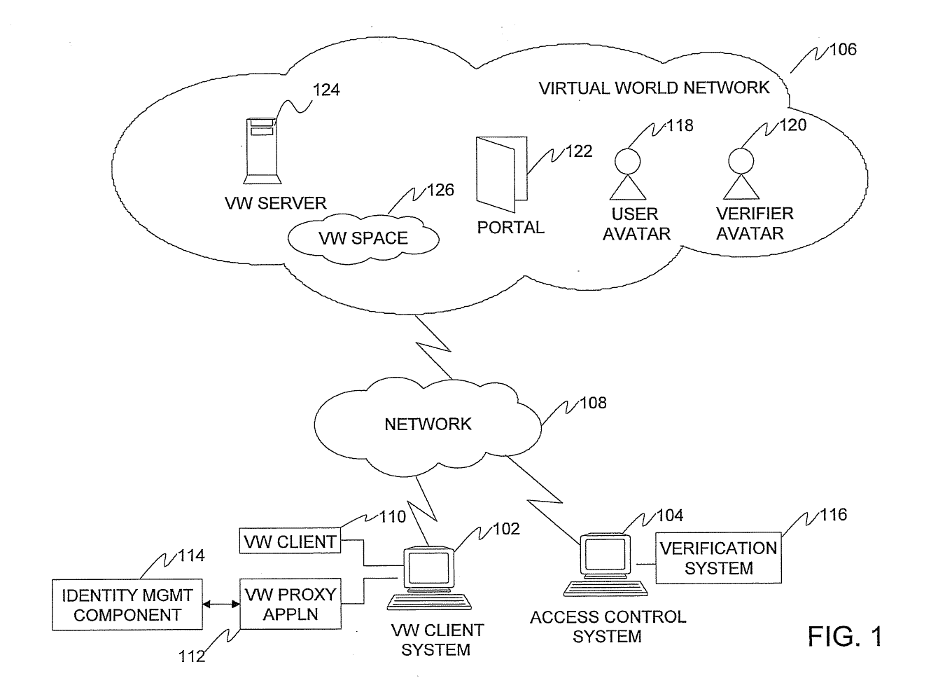

Turning now to the drawings in greater detail, it will be seen that in FIG. 1 there is a system upon which virtual world (VW) access control management may be implemented in an exemplary embodiment. The VW access control management processes provide a solution which allows a user to prove certain attributes about himself in an anonymous fashion to become a member of a virtual world (VW) group, and thus gain access to virtual world (VW) spaces. The VW access control management system verifies the proof without any pre-existing relationship with the user.

The following definitions are provided for ease of description.

Virtual world. A virtual world refers to a computer-based environment that includes real world-based objects (avatars, personalities, icons, places, etc.) used by users who interact and inhabit one or more VW spaces in the virtual world.

Virtual space. A virtual space refers to a specific portion of a virtual world for which access is granted to a select group of users (i.e., VW space members).

Avatar. A computer-based graphical or text-based representation of a user or program in a virtual world.

The system of FIG. 1 includes a virtual world (VW) client system 102, an access control system 104, and a virtual world (VW) network 106, each of which is in communication with a network 108. The VW client system 102 may be operated by an authorized member of the VW network 106, and which member does not have access to a particular VW space (e.g., VW space 126) within the VW network 106. The VW client system 102 may be implemented by any type of computer processing system (e.g., general-purpose computer). The VW client system 102 accesses the VW network 106 via a virtual world (VW) client application 110 executing on the VW client system 102.

The access control system 104 may be operated by an individual who is not a member of the VW network 106 and is independent from the VW network 106. The access control system 104 processes requests for access to the VW network 106 (and, optionally, other VW networks) and is not otherwise associated with the VW network 106; that is, system 104 is independent. The access control system 104 may be implemented by any type of computer processing system (e.g., general-purpose computer).

Network 108 may be any type of known network including, but not limited to, a wide area network (WAN), a local area network (LAN), a global network (e.g. Internet), and an intranet.

The VW client system 102 executes a VW client application 110 (e.g., SecondLife) for communicating with the VW network 106. As shown in FIG. 1, the VW network 106 includes a user avatar 118 which represents the user of VW client system 102. In an exemplary embodiment, the VW client system 102 executes a VW proxy application 112 that intercepts specified communications between the VW client system 102 and the VW network 106. For example, the proxy application 112 intercepts policy objects issued by objects within the VW network 106. A policy object, as used herein, refers to an object containing formally specified authentication requirements or credentials (e.g., a policy object specifies that the user must provide his nationality and age range endorsed by the Swiss Government in order to be granted the desired access, whereby the nationality and age comprise the credentials required for access). Each of the VW spaces in the VW network 106 (as well as other VW networks) may require different credentials, and therefore, issue different policy objects.

The VW client 102 also implements an identity management component 114 which, in turn, communicates with the VW proxy 112. The identity management component 114 receives a policy object from the VW network 106, via the proxy 112, and selects an identity that fulfills the policy object. The VW client system 102 includes memory for storing one or more identities. Identities may be derived from, e.g., a passport, birth certificate, social security card, employment record, motor vehicle record or drivers license, Internal Revenue Service record, bank account, and credit card account, as well as a proprietary collection of identity attributes prescribed by an issuer.

The VW network 106 may implement a VW server 124 including logic for enabling members of the VW network 106 to communicate with one another, share information and resources, and other options typically provided in a VW network system. The VW network 106 may include a portal object 122 that serves as the contact point for user-controlled avatars (e.g., user avatar 118). The VW network 106 further includes a verifier avatar 120 that is logically mapped to, and controlled by, the access control system 104 located outside of the VW network 106 (e.g., over network 108). The verifier avatar 120 may be logically mapped to the access control system 104 via a verification application 116 executing on the access control system 104. The verification application 116 is implemented by automated software (i.e., the verifier avatar 120 is a bot (robot)) that is controlled by the software, which performs the various access control functions described herein.

The configuration shown in FIG. 1 is for illustrative purposes only. It will be understood by those skilled in the art that the VW access control management may be implemented using various different configurations. For example, the VW network 106 may include multiple VW spaces, whereby a VW member may be authorized, via the VW client application 110, to access one or more of the VW spaces. The VW access control management enables a VW client system to request and receive access to VW spaces. In addition, a verifier avatar and corresponding verifier application may be configured to manage one or more VW spaces within a VW network or a single verifier avatar 120 may manage the access controls for an entire VW network.

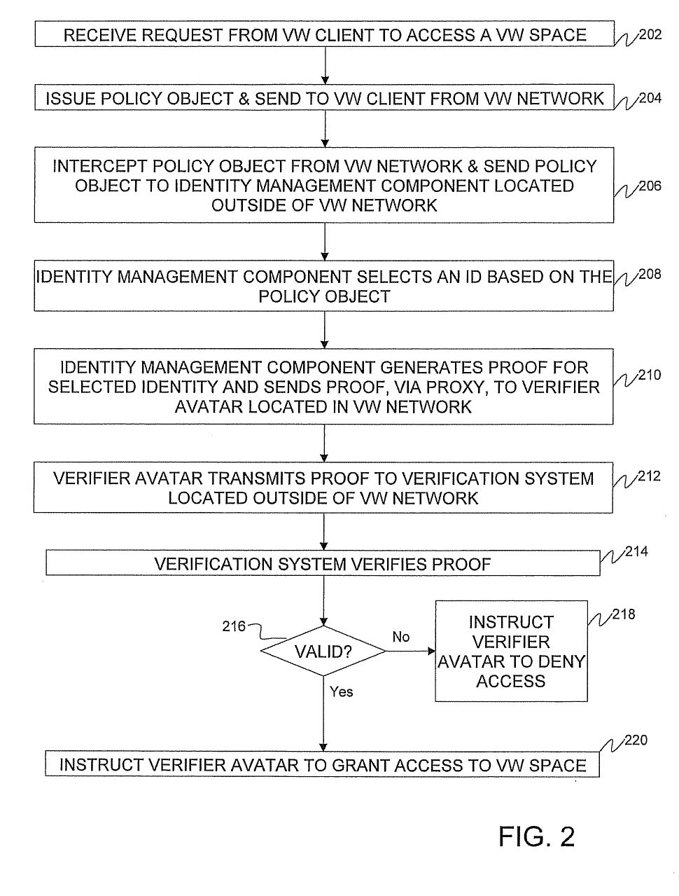

Turning now to FIG. 2, a process for implementing VW access controls will now be described. At step 202, the VW network 106 receives a request from a user (e.g., an access requester operating on VW client system 102) to access a VW space (e.g., VW space 126) within the network 106. The user request may be made via the VW client application 110 over network 108. An object located within the VW network 106 (e.g., the portal object 122) issues a policy object and transmits the policy object to the VW client system 102 at step 204. As indicated above, the policy object issued is based upon the nature of access desired. The proxy application 112 intercepts the policy object transmission and sends the policy object to the identity management component 114 on the VW client system 102 at step 206. It will be understood that the VW proxy application 112 may be executed on the client system 102 or may be executing on a separate computer system in communication with the client system 102, outside of the VW network 106. As shown in FIG. 1, the VW client system 102 is located outside of the VW network 106.

In response to the policy object, the identity management component 114 selects an identity that fulfills the policy object at step 208. The identity is used to verify a set of credentials associated with the user (i.e., access requester). As indicated above, credentials may be in the form of passport data, driver's license data, credit card data, employment records, etc. Thus, if the policy object requires that a user's age and nationality be provided as proof of identity, the identity selected may be an electronic passport or birth certificate. The identities may be implemented using proprietary tools or may be provided as a service utilizing a framework, such as the Eclipse-hosted Project Higgins, an open source framework for providing Internet-based identity management services. Other examples of credentials include, e.g., user name, user address (physical and/or network), telephone number, social security number, account number, occupation, employment information, education information, and any proprietary data prescribed by an issuer.

The identity management component 114 generates proof for the selected identity of the user and, via the VW proxy 112, transmits the proof over the network 108 to the VW network 106, and in particular, to the verifier avatar 120 at step 210. The verifier avatar 120, in turn, transmits the proof of identity over network 108 to the access control system 104 at step 212. The verification system 116 verifies the proof of identity at step 214. The verification may be accomplished based upon the means by which the proof of identity is generated; that is, using the same algorithm suite. For example, if the generation of proof is done using a specific anonymous credential system, the verification is done using the verification algorithm of this credential system. This may be implemented, e.g., by using Higgins server-side components. It will be understood, however, that other means of verification may be used, e.g., the identity management component 114 may contact an external party, such as an identity provider to obtain a proof token. These, and other, types of verification processes are contemplated by the VW access control management system.

If the proof is not valid at step 216, the verification system 116 instructs the verifier avatar 120 to deny the user of the VW client system 102 access to the requested VW space 126 at step 218. Otherwise, at step 220, the verification application 116 instructs the verifier avatar 120 to provide the VW client system 102 with access to the requested VW space 126 in the VW network 106. The verifier avatar 120, in turn, places the access requester onto a list of avatars that may enter the VW space. That is, the verifier avatar 120 interacts with the VW system, which later enforces the access control via the list.

In an alternative embodiment, the verification application 116 may track the number of avatars on this list and may refuse access to the VW space if too many avatars have accessed the space (e.g., where the maximum number of avatars in the VW space at one time is pre-selected as desired). In another embodiment, the verification application 116 may track the number of avatars on the list and remove one or more avatars from the list after a designated amount of time. The amount of time granted may depend upon various attributes proven by the user. In another embodiment, a verification plug-in (or DLL) may be used for the VW client application 110 instead of the VW proxy 112 if supported by the VW client system 102.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

1. A method for virtual world (VW) access control management, comprising:
intercepting a policy object from a VW network in response to a request from a VW client system to access a VW space in the VW network, the policy object intercepted by a proxy server that is located outside of the VW network;
selecting an identity based upon the policy object, the identity selected providing credentials required in the policy object as a condition of granting access to the VW network;
generating proof from the selected identity and transmitting the proof to a verifier avatar located inside the VW network, the verifier avatar logically mapped to, and controlled by, a verification system that is located outside of the VW network;
receiving at the verification system, the proof from the verifier avatar; and
in response to successful validation of the proof by the verification system, the verification avatar places an avatar associated with the VW client system on a list of avatars that are authorized to access the VW space;
wherein each of the identities provides one or more credentials associated with the user.

2. The method of claim 1, wherein the identities are derived from information sources, wherein the identities include at least one of:
a passport;
a birth certificate;
a social security card;
an employee record;
a bank account record;
a credit card account record;
an Internal Revenue Service record;
a drivers license record;
a motor vehicle record; and
a proprietary collection of identity attributes prescribed by an issuer.

3. The method of claim 1, wherein the credentials include at least one of:
a user name;
a user age;
a physical address;
a network address;
a telephone number;
a social security number;
an account number;
an occupation;
employment information;
education information; and
proprietary data prescribed by an issuer.

4. A system for virtual world (VW) access control management, comprising:
a VW client system in communication with a verification avatar that is located inside of a VW network and an access control system located outside of the VW network;
a proxy application and an identity management component executing on the VW client system, the proxy application and the identity management component implementing a method, comprising:
intercepting a policy object from the VW network in response to a request from the VW client system to access a VW space in the VW network, the policy object intercepted by the proxy server;
selecting an identity based upon the policy object, the identity selected providing credentials required in the policy object as a condition of granting access to the VW network;
generating proof from the selected identity and transmitting the proof to the verifier avatar, the verifier avatar logically mapped to, and controlled by, a verification system that is located outside of the VW network and which is executing on the access control system;
receiving at the verification system, the proof from the verifier avatar; and
in response to successful validation of the proof by the verification system, the verification avatar places an avatar associated with the VW client system on a list of avatars that are authorized to access to the VW space;
wherein each of the identities provides one or more credentials associated with the user.

5. The system of claim 4, wherein the identities are derived from information sources, wherein the identities include at least one of:
a passport;
a birth certificate;
a social security card;
an employee record;
a bank account record;
a credit card account record;
an Internal Revenue Service record;
a drivers license record;
a motor vehicle record; and
a proprietary collection of identity attributes prescribed by an issuer.

6. The system of claim 4, wherein the credentials include at least one of:
a user name;
a user age;
a physical address;
a network address;
a telephone number;
a social security number;
an account number;
an occupation;
employment information;
education information; and
proprietary data prescribed by an issuer.
